(19) United States
(12) Patent Application Publication
(10) Pub. No.: US 2002/0152684 A1
(43) Pub. Date: Oct. 24, 2002

(54) Control of the movement of a sliding or swinging and sliding door in its end closing area

(76) Inventor: Martin Fink, Waidhofen a.d. Ybbs (AT)

Correspondence Address: FRIEDRICH KUEFFNER, 317 MADISON AVENUE, SUITE 910, NEW YORK, NY, 10017, US

(21) Appl. No.: 09/980,747

(22) PCT Filed: Mar. 14, 2001
(86) PCT No.: PCT/AT01/00070

(30) Foreign Application Priority Data
Mar. 16, 2000 (AT) A 427/2000

(51) Int. Cl. E05C 7/06

(52) U.S. Cl. 49/121; 49/366

(57) ABSTRACT

The invention concerns a control of the movement of a sliding or swinging and sliding door (1) in its end closing area (X), wherein by means of a free wheel (8) or the like the movement of the door leaf (2) in the closing direction is possible always, but the movement in the opening direction is possible only when a brake, coupling (9) or other fixation for the part of the free wheel remote from the door leaf is lifted, and wherein a device for determining the door position is present.

The invention is characterized in that possibly present conventional measures as safety devices against pinching in the predetermined end closing area (x) are deactivated; that, as long as the door leaf (2) is within the end closing area (x), the current supply of the door drive (4) and thus the closing force acting on the door leaf is reduced; and that the brake, coupling (9) or the like, which acts onto the part of the free wheel (8), remote from the door leaf, is lifted.

The invention also concerns modifications of this basic idea.

The invention relates to a control of the movement of a sliding or swinging and sliding door of a vehicle in its end closing area wherein, by means of a free wheel, a ratchet, or the like, the movement of the door leaf in the closing direction is always possible, but the movement in the opening direction only when a brake, coupling or other fixation for the part of the free wheel remote from the door leaf is lifted, and wherein a device for determining the door position is present. Such a door, for example, is known from EP 0 673 464 A, corresponding to AT 401 082 B. The contents of these publications are included by reference into this description.

For automatic doors of all kinds, which are remote-controlled or actuated by an automatic time control or the like, measures are provided in order to prevent that persons or objects can be pinched by the closing door and can thus be injured or damaged in this way or that it occurs that persons or objects caught in this way remain caught when the train is moving.

In many cases, sensors are used in the sealing area of the main closing edge of the door in order to detect such a pinching. The main closing edge refers to that vertical edge of the door which upon closing movement of the door is leading. The vertical edge which during the closing movement of the door is trailing is the auxiliary closing edge. For double-wing doors, the main closing edges of the symmetrically arranged wings abut one another in the closed state of the door, while the auxiliary closing edges rest against the door frame.

In the area of the seals of these main closing edges, often in the interior of the hollow seals, corresponding sensors are arranged which recognize when the seal, before reaching the closed end position, impacts on an obstacle resulting in the possibility or risk of pinching a person or an object. Known strategies for operating the closing mechanisms of such doors reside in that either the drive device is reversed and after a predetermined time a new closing attempt is undertaken or the closing process is interrupted for a predetermined time in order to allow the passengers to remove objects, which up to this point have only been slightly pinched, if at all, and to subsequently complete the closing process. All of these and other strategies have different advantages and disadvantages, such as the time expenditure, the control expenditure and the energy expenditure, and require in many cases in addition to this control also components and attachments in the door area, in particular, also the sensors which are expensive with respect to their servicing.

Of course, there are also other methods and devices as a safety measure against becoming pinched; however, since none of them does relate to the problems addressed in the following, they will not be explained in more detail in this context.

In many cases, pinching of an arm, a leg, a bag, a dog occurs in the last part of the closing movement, in the so-called closing end area. When in this context the entire safety process is carried out, i.e., the door is again opened and the closing process is then again repeated, entirely superfluous delays will result which, moreover, invite the public to open other doors in order to board, which causes even more delays in the boarding process.

The size of the aforementioned end closing area can be determined by the respective operator of the train or can be determined by law for each state and, in most cases, is approximately 150 mm, measured at the main closing edge and starting from its closed end position or between the main closing edges for double-wing doors. In the following, the term end closing area is used in connection with the door leaf as well as in connection with different parts of the door leaf or the door drive. Since each of these parts has a defined position when the door leaf (even more precisely: its main closing edge) has reached the closing end area, this wording is clear and definite.

It is an object of the invention to provide for a door of the aforementioned kind a safety device against pinching, in particular, for the end closing area of the door, wherein this no longer concerns the release of persons as a whole but instead the goal to not separate luggage or dogs or the like from the correlated person, which device is operated only by the door control itself, provides the greatest possible safety, and eliminates additional components in the door area and thus also the required servicing and inspection of such components, which are otherwise always required.

According to the invention it is therefore proposed that possibly present conventional measures as a pinch-protection in the predetermined end closing area are deactivated; that, as long as the door leaf is in the closing end area, the electric current supply of the door drive and thus the closing force, which acts onto the door leaf (the door leaves) is reduced such that a stopping and opening of the door leaf (the door leaves) for normal users is possible despite the electric current supply; and that the brake, coupling or the like, which acts onto the part of the free wheel remote from the door leaf, is lifted.

This makes it possible that no time-consuming measures in the end closing area are carried out, as they were required previously, but that only the passenger has the option to push the door open to such an extent that he can pull in bags, umbrellas etc. through the pushed-open gap. When the opening force ceases, the closing process is immediately continued.

In this connection it is provided according to the invention that the manual pushing-open of the door during the interrupted closing process is possible only across the predetermined end closing area and that, when the monitoring device for the door position has determined that this predetermined area has been left behind, the brake, coupling or the like is again engaged so that a further opening is not possible. In this way it is possible to free pinched objects, but it is prevented that the doors will become the playground for youths or irresponsible persons.

In one embodiment of the invention it is furthermore provided that after a predetermined time the brake, coupling or the like is engaged in any case (for normal closing it will engage anyway upon reaching the end position or when locking occurs) in order to be able to maintain operation in any case. Since the train driver, when the train is leaving, can overlook the doors at least for the most part, no safety problems can occur.

In a further variant it can be provided that the brake, coupling or the like engages when the train reaches a predetermined speed.

In yet another variant it can be provided that, upon leaving the station, the brake, coupling or the like can be actuated by a signal. With this embodiment, operation is possible even when a complete closure of the door leaf has not been achieved, even though this is desirous as described in the following, because of the reduced closing force within the end closing area or because of the wanton pinching of beverage cans—a favorite pastime of some youths.

The force with which the door leaf is loaded within the end closing area must be, on the one hand, so great that even for a soiled guide and solidified or lack of lubricant (winter operation, dry run) closing is possible reliably but that, on the other hand, even children or weak persons can stop the door leaf and can open it against the closing force within the closing end area. Conventionally, closing forces in the range of 50 to 150 N, preferably of approximately 75 N, are suitable for this purpose.

The invention can be configured in most different ways and adapted to the conditions of use. For example, the end closing area in which the brake, coupling or the like is lifted can be greater than the area in which the closing force is reduced. This achieves that in an emergency situation the doors can be opened father by a great force expenditure than with a normal force action.

The invention will be explained in the following purely schematically with the aid of the drawings:

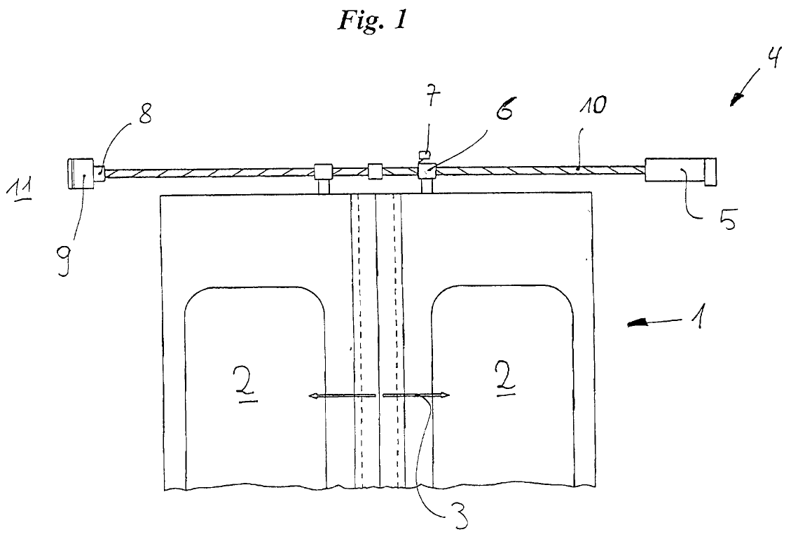

FIG. 1 shows a door which is furnished according to the invention, in the closed state;

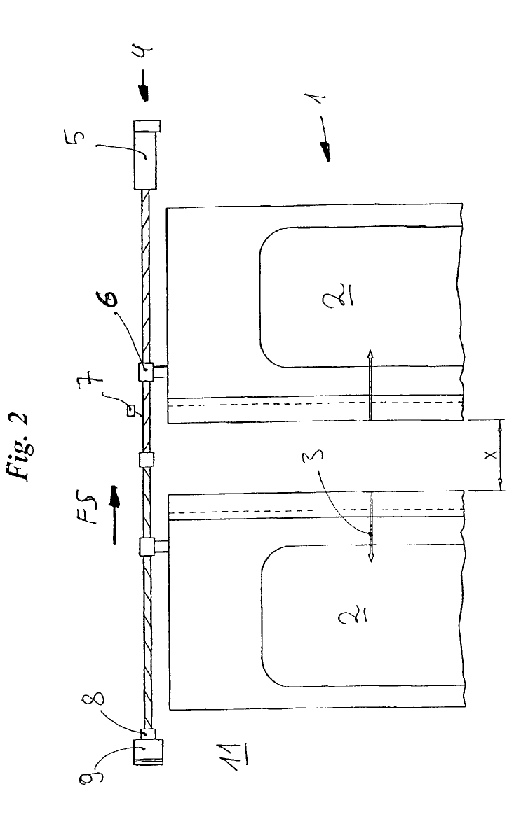

FIG. 2 shows the door of FIG. 1 with the door leaves in the closing end area; and

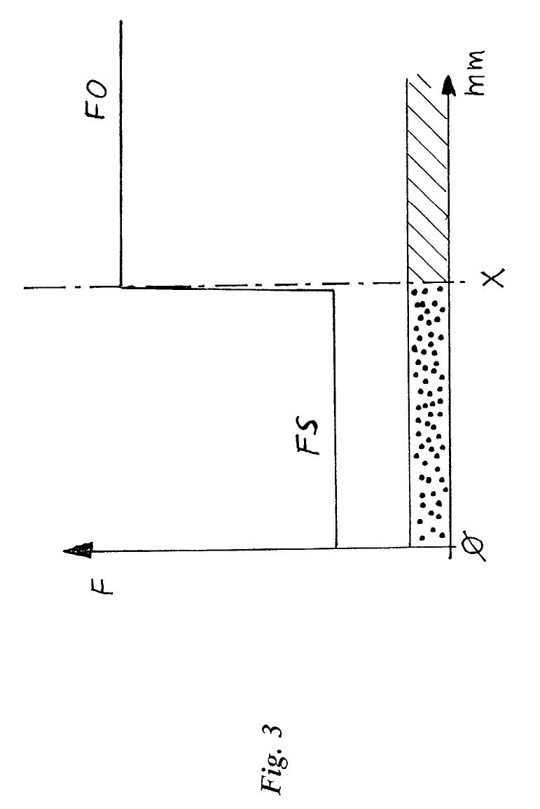

FIG. 3 shows some operating states within and outside of the closing end area.

FIG. 1 shows, purely schematically, a door 1 with two door leaves 2. These are moved by a door drive 4 between their closed and their open positions. The actual guides are not illustrated in order to avoid cluttering the drawing. The door drive 4 is comprised substantially of a motor 5 which drives a spindle 10 in rotation, with integrated position transponder which determines, by monitoring the rotational movement of the spindle, the position of the door leaves 2. Each door leaf 2 is fixedly connected by means of an arm with a nut 6 threaded onto a spindle 10 so that upon rotation of the spindle 10 each door leaf 2 is moved correspondingly.

The spindle 10 supports at the end facing away from the motor 5 a free wheel 8 which cooperates with the spindle such that a rotational movement in the direction, which corresponds to the closing direction of the door leaf, is always possible. The rotational movement in the counter direction, however, is blocked by it. In order to be able to open the door, it is provided that the end of the free wheel 8 remote from the spindle is not fixedly fastened on the car body 11 but is connected by means of a coupling 9 or a brake or a similar releasable mechanism. This achieves that, upon releasing the coupling 9, the part of the free wheel 8 remote from the spindle can move in the opening direction and makes possible the opening of the door 1.

In FIG. 1, the closed position of the door is illustrated, the end switch 7 has recognized this “position” and has switched off the electric current supply of the door drive and the door or the door leaves 2 are locked. A possibly applied force 3 in the opening direction cannot push the door open.

FIG. 2 shows the door 1 at the border of the closing end area. Depending on the applied standard or the applied law, the width x is of a different magnitude, in most cases it is 150 mm. Upon closing of the door outside of the closing end area, each door leaf is loaded with a closing force FO which ensures a quick closing action. According to the invention, within the closing end area, upon normal closing of the door 1, the closing force is lowered to a predetermined value FS (schematically indicated in the area of the nut 6) which is selected such that, on the one hand, it allows a complete closing even under adverse conditions (cold, dry run, soiled guides), and, on the other hand, prevents reliably injury of persons or animals. At the same time, in this area the coupling 9 is lifted so that the users of the door can open it against the reduced closing force FS (inasmuch as the applied force 3 is greater than the closing force FS) because in this way a reversal of the rotational direction of the spindle is enabled.

This course of action can be seen in FIG. 3 which schematically shows the course of the closing force across the closing movement as a function of the respective position of the door leaf: As long as the end closing area x has not yet been reached, the closing force FO is present at the door leaf; when reaching the closing end area, the closing force is reduced to the predetermined lower value FS. At the same time, the brake which has been engaged up to this point (hatched area) is lifted (dotted area) and in this way the free wheel becomes moveable even in the otherwise locked rotational direction.

The position transponder in the motor 5 recognizes that the end closing area has been reached or left and, in the latter case, engages again the coupling 9 in order to prevent “playing” with the door.

The opening of the door is realized, as is conventional with these systems, by the brake or the like being lifted, and the door drive then acts with the predetermined, mostly full, force.

As can be taken from the above, there are many possibilities to realize the invention technically. For example, the position transponder can be provided separately from the motor and can also comprise and fulfill at the same time the end switch 7 and its function; it is also possible in the case of double-wing doors that the spindle acts only on one wing and that the other wing can be driven by means of a circulating band or the like; it is possible to provide the free wheel and the coupling at the motor even when this is expedient only in exceptional situations because of the complex support of the motor; and many other variations.

It is important that, in the end closing area of the door 1 or the door leaf 2, its closing force is reduced from FO to FS, that its opening lock is released, and that, if present, in the end closing area x other mechanisms to prevent pinching are deactivated.

1. Control of the movement of a sliding or swinging and sliding door (1) in the end closing area (X) of the door leaf (2), wherein by means of a free wheel (8) or the like the movement of the door leaf (2) in the closing direction is possible always, but the movement in the opening direction is possible only when a brake, coupling (9) or other fixation for the part of the free wheel remote from the door leaf is lifted, and wherein a device for determining the door position is present, characterized in that possibly present conventional measures as safety devices against pinching in the predetermined end closing area (x) are deactivated; that, as long as the door leaf (2) is within the end closing area (x), the current supply of the door drive (5) and thus the closing force (F) acting on the door leaf (2) is reduced to a lower value (FS); and that the brake, coupling (9) or the like, which acts onto the part of the free wheel (8), remote from the door leaf, is lifted.

2. Control according to claim 1, characterized in that the brake, coupling (9) or the like engages when a predetermined time interval has elapsed.

3. Control according to claim 1, characterized in that the brake, coupling (9) or the like engages when the train has reached a predetermined speed.

4. Control according to claim 1, characterized in that the brake, coupling (9) or the like is effected upon leaving of the station by a signal transponder located on the station platform.

5. Control according to one of the preceding claims, characterized in that the end closing area (x) is approximately 150 mm.

6. Control according to one of the preceding claims, characterized in that the closing force (FS) on the door leaf (2) in the end closing area (x) is 50 N to 150 N, preferably approximately 75 N.

7. Control according to one of the preceding claims, characterized in that the end closing area (x) is approximately 150 mm.
